(19) United States
(12) Patent Application Publication
(10) Pub. No.: US 2024/0319696 A1
(43) Pub. Date: Sep. 26, 2024

(54) MULTI-STAGE CYCLIC WATER RESOURCE CONTROL SYSTEM AND METHOD OF SAME

(71) Applicant: TIANJIN UNIVERSITY, Tianjin (CN)

(72) Inventors: Li HE, Tianjin (CN); Yang XU, Tianjin (CN); Tong SUN, Tianjin (CN); Mengxi HE, Tianjin (CN); Yuxuan XUE, Tianjin (CN); Wenming MA, Tianjin (CN)

(21) Appl. No.: 18/610,071

(22) Filed: Mar. 19, 2024

(30) Foreign Application Priority Data
Mar. 23, 2023 (CN) 202310292357.0

(51) Int. Cl. G05B 19/042

(52) U.S. Cl. CPC G05B 19/042; G05B 2219/2605

(57) ABSTRACT

A multi-stage water resource-recycling control system includes a sewage treatment device, a temperature feedback controller, a flow rate feedback controller, a decider, and a feedback controller group; wherein the output end of the sewage treatment device is connected with the input ends of the temperature feedback controller and the flow rate feedback controller, respectively; the output ends of the temperature feedback controller and the flow rate feedback controller are connected with the input end of the decider; the output end of the decider is connected with the input ends of the sewage treatment device and the feedback controller group, respectively; the output end of the feedback controller group is connected with the input end of the sewage treatment device. The objective of the present disclosure is to ensure that the output-water quality reaches the standard.

### CROSS-REFERENCE TO RELATED APPLICATION

This application claims priority from the Chinese patent application 202310292357.0 filed Mar. 23, 2023, the content of which is incorporated herein in the entirety by reference.

### TECHNICAL FIELD

The present disclosure relates to the technical field of environmental engineering, in particular to a multi-stage cyclic water resource control system and a method of same.

### BACKGROUND

In the prior art, a sewage treatment technology is mainly classified into a physical treatment, a chemical treatment, and a biological treatment. The physical treatment refers to a method of exerting a physical action to separate pollutants mainly suspended in sewage, which mainly includes precipitation, screening, flotation, centrifugation and cyclonic separation. The chemical treatment refers to a method of adding chemical substances to sewage to exert a chemical reaction to separate and recycle pollutants in sewage, or convert them into harmless substances, which mainly includes a neutralization process, a redox process, an electrolysis process, an adsorption process, a chemical precipitation process and so on. The biological treatment refers a method of taking a given artificial measure to create an environment conducive to the growth and reproduction of microorganisms to enable the microorganisms to propagate, so as to promote the oxidation and decomposition of microorganisms exerted on organic pollutants, which are degraded and converted into harmless substances, so that sewage can be purified. This method may be classified into two kinds: an aerobic treatment and an anaerobic treatment.

In general, a flow rate and water temperature acting as a reaction condition for sewage treatment has a great influence on a pollutant removal rate. As treated water resources differ in use and destination, the water quality indexes and output-water standards necessary to be monitored in the sewage treatment process are also different, correspondingly the chemicals that need to be put thereinto are also different. Since the foundation for the sewage treatment industry in China is relatively weak, there are still many defects in traditional sewage treatment technologies with occurrence of imbalances and mis-adjustments and the likes during installing and using equipment.

For example, Yin Fengjun, Xu Zeyu and Liu Hong had proposed an idea of constructing an intellectualized system of controlling sewage treatment based on the integration of a mechanism model and a data model, but in actual operation, a divorce between the design-operation state of a sewage plant and an on-site water quality and operation conditions causes a waste of energy and material consumption and an increase in operating costs. Intellectualization is an inevitable trend of the development of sewage treatment technology, but the development of intellectualized sewage treatment lacks the promotion of model innovation, so it is necessary to break through the difficulty of online obtaining water quality data, and further establish and refine the technical solution about intellectualized control that integrates a mechanism model with a data-driven model. Therefore, at present, it is necessary for a more intellectualized and automated control system to continuously optimize and improve the treatment system, so as to achieve the purpose of saving pharmaceutical costs, time costs and labor costs while reaching water quality standards.

### SUMMARY

The objective of the present disclosure is to adjust sewage treatment conditions such as temperatures, flow rates, chemical addition quantities, aeration parameters, and microbial addition quantities in real time according to input-water by way of providing a water resource control system through multi-stage cyclic feedback and a method of same to ensure that the output-water quality reaches the standard, so as to achieve high-efficient sewage treatment and solve the problems such as insufficient intellectualization of traditional sewage treatment technologies, waste of energy and material consumption, delay of online obtaining water quality data, and lack of online monitoring methods for water quality.

In order to solve the above technical problem, the technical scheme adopted in the present disclosure is as follows:
A multi-stage cyclic water resource control system, comprises a sewage treatment device, a temperature feedback controller, a flow rate feedback controller, a decider, and a feedback controller group;
the output end of the sewage treatment device is connected with the input ends of the temperature feedback controller and the flow rate feedback controller, respectively; the output ends of the temperature feedback controller and the flow rate feedback controller are connected with the input end of the decider; the output end of the decider is connected with the input ends of the sewage treatment device and the feedback controller group, respectively; the output end of the feedback controller group is connected with the input end of the sewage treatment device.

The feedback controller group comprises a y₁ feedback controller, a y₂ feedback controller, a y₃ feedback controller, . . . , and yₘ feedback controller, where m is a positive integer;
the output end of the decider is connected with the input ends of the sewage treatment device and the y₁ feedback controller, respectively; the output end of the y₁ feedback controller is connected with the input ends of the sewage treatment device and the y₄ feedback controller, respectively; the output end of the y₂ feedback controller is connected with the input ends of the sewage treatment device and the y₃ feedback controller, respectively; and so on, until the output end of the yₘ feedback controller is connected with the input end of the sewage treatment device.

The temperature feedback controller, the flow rate feedback controller, and each feedback controller in the feedback controller group each contains a sensor, an optimizer, an emulator, a controller, and a controlled component, the output end of the sensor is connected with the input end of the optimizer, the output end of the optimizer is connected with the input end of the emulator, and the output end of the controller is connected with the emulator and the controlled component, respectively;
a first error regulator is arranged between the output ends of the optimizer and the controller, the information output by the optimizer and the controller is transmitted to the first error regulator, then the first error regulator acts on the controller to update control variables after having made an adjustment according to the error between the optimizer and the controller;
a second error regulator is arranged between the output ends of the emulator and the controlled element, the second error regulator acts on the emulator to update an internal optimization model after having made an adjustment according to the error between the output ends of the emulator and the controlled component, so as to correct an expected state of a next round of optimization and continuously carry out a cyclic feedback adjustment; an optimal control step needs to be given under internal control by way of repeating the prediction and optimization of an intellectualized algorithm in each time stage, and then the output solved by the controller acts on the sewage treatment device when the optimal solution of the optimization problem has been obtained.

The operation of the temperature feedback controller, the flow rate feedback controller and each feedback controller in the feedback controller group follows the steps of
S1: enabling a sensor to detect an input-water index X(t+tₐ) of water resources at a moment t+tₐ, then transmit information to an optimizer, then entering S2;
S2: enabling the optimizer to perform optimization and seek the solution according to a set water quality target value and a real-time simulation model input from an emulator, and give a current control variable U(t+tₐ), meanwhile entering S3 and S4;
S3: enabling a control variable U(t+tₐ) to act on the emulator for simulation to output a result Y_{d}(t+tₐ+Δt), then entering S7;
S4: enabling a controller to actually output a control variable U′(t+tₐ) according to existing data after having received the information that the optimizer transmits, then entering S5;
S5: enabling the information U(t+tₐ) output, controlled and calculated by the optimizer and the information U′(t+tₐ) actually output by the controller to be transmitted to a first error regulator, and enabling the first error regulator to act on the controller for an adaptive stability adjustment of the controller after having made an adjustment according to the error between the above two, then entering S6;
S6: enabling an actual output control variable U′(t+tₐ) to act on the sewage treatment device to output an actual output variable Y(t+tₐ+Δt), if the error between the actual output variable Y(t+tₐ+Δt) and a target value is bigger than an allowable error, then entering S7; if the error between the actual output variable Y(t+tₐ+Δt) and a target value is smaller than an allowable error, then entering S8;
S7: enabling the information output by the emulator and a controlled component to be transmitted to a second error regulator, and enabling the second error regulator to act on the emulator to update a real-time simulation model after having made an adjustment according to the error between the above two, then entering S2; and
S8: continuously carrying out cyclic feedback to adjust and optimize the target, the error between an actual water treatment effect and a target value being less than an allowable error, thus achieving optimization control.

The specific real-time simulation model of the temperature feedback controller, the flow rate feedback controller and an internal emulator inside the feedback controller group is as follows,

$$min J ( y , u ) = {\sum }_{k = 1}^{N} {‖ y ( t + k ) - {y}_{d} ( t + k ) ‖}^{2}$$

$$s . t .$$

$$y ( t + 1 ) = f ( y ( k ) , u ( t ) ) \qquad ( 1 )$$

$$u ( t ) ∈ [ u , \overline{u} ] , t ∈ T \qquad ( 2 )$$

$$y ( t ) ∈ [ y , \overline{y} ] , t ∈ T \qquad ( 3 )$$

where, external constraints: the objective function indicates that the state y(t+k) and the desired state y_{d}(t+k) of the system should be close to each other as far as possible within coming N time stages; wherein Constraint (1) represents the dynamic characteristics of a controlled object, f represents an expected model not limited to various machine learning algorithms including a recurrent neural network, Constraints (2) and (3) represent the upper and lower limits of a control parameter u(t) and a state parameter y(t) for water treatment, respectively.

Compared with the prior art, the present disclosure has the following technical effects.
1) The multi-stage water resource-recycling control method firstly adjusts the control variables such as temperatures and flow rates acting as factors influencing on wastewater treatment, so as to enable the use efficiency of chemicals and the operation efficiency of equipment to reach the maximum, secondly reduces costs for chemicals, electricity, equipment operation and maintenance and the likes.
2) The multi-stage cyclic water resource control system composed of various feedback controllers through series-parallel combinations reduces the size of the smallest independent unit in the sewage treatment process, lowers the complexity of the mechanism model, and enhances the controllability and predictability of the reaction unit.
3) The present disclosure can widen control indexes, add other input-water indexes to the control system, add a pH value to an one-stage cycle, and add many water quality indexes such as COD, BOD, NH₃—N, NO⁻₃—N, NO⁻₂—N, TN, TP, DO concentration, colourity and turbidity to a multi-stage cycle.
4) As the system is easy to operate and has stronger applicability and flexibility, it can be applied to a variety of treatment methods such as physics, chemistry, biology and a variety of circumstances such as a one-stage treatment, a two-stage treatment and a three-stage treatment to meet the requirements of indexes for various water resources.
5) The present disclosure enables online monitoring of water quality data, real-time observation of the state of a sewage treatment process and the abnormal state of input-water to achieve the purpose of rapid regulation and control, so as to ensure that the output-water quality meets the relevant standards and the system is always in an optimal state.

### BRIEF DESCRIPTION OF THE DRAWINGS

We shall further describe the present disclosure as follows in combination with the drawings and examples.

FIG. 1 is a diagram of the multi-stage cyclic water resource control system.

FIG. 2 is a block diagram of the temperature feedback controller, the flow rate feedback controller, and each feedback controller in the feedback controller group.

FIG. 3 is a flow chart of the multi-stage water resource-recycling control method.

FIG. 4 is a block diagram of the temperature feedback controller.

FIG. 5 is a block diagram of the flow rate feedback controller.

FIG. 6 is a block diagram of the y₁ feedback controller.

FIG. 7 is a block diagram of the y₂ feedback controller.

FIG. 8 is a block diagram of the y₃ feedback controller.

FIG. 9 is a block diagram of the yₘ feedback controller.

### DETAILED DESCRIPTION OF SOME EMBODIMENTS

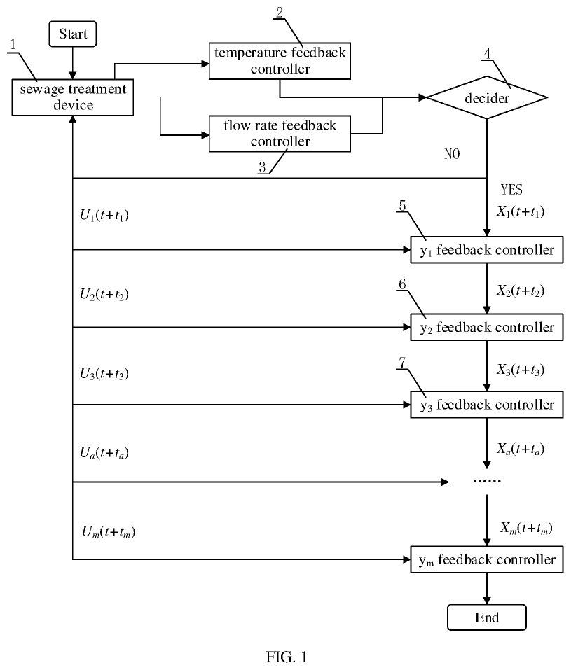

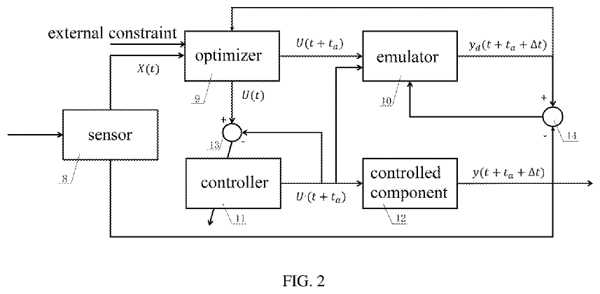

As shown in FIGS. 1-3, a multi-stage cyclic water resource control system includes a sewage treatment device 1, a temperature feedback controller 2, a flow rate feedback controller 3, a decider 4, and a feedback controller group.
the output end of the sewage treatment device 1 is connected with the input ends of the temperature feedback controller 2 and the flow rate feedback controller 3, respectively; the output ends of the temperature feedback controller 2 and the flow rate feedback controller 3 are connected with the input end of the decider 4; the output end of the decider 4 is connected with the input ends of the sewage treatment device 1 and the feedback controller group, respectively; the output end of the feedback controller group is connected with the input end of the sewage treatment device 1.

The feedback controller group comprises a y₁ feedback controller 5, a y₂ feedback controller 6, a y₃ feedback controller 7, . . . , and yₘ feedback controller, where m is a positive integer;
the output end of the decider 4 is connected with the input ends of the sewage treatment device 1 and the y₁ feedback controller 5, respectively; the output end of the y₁ feedback controller 5 is connected with the input ends of the sewage treatment device 1 and the y₄ feedback controller 6, respectively; the output end of the y₂ feedback controller 6 is connected with the input ends of the sewage treatment device 1 and the y₃ feedback controller 7, respectively; and so on, until the output end of the yₘ feedback controller is connected with the input end of the sewage treatment device 1.

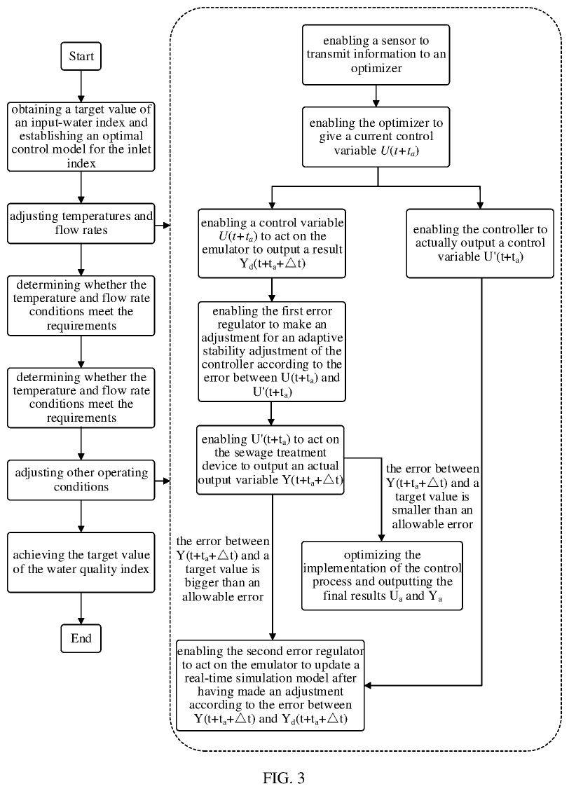

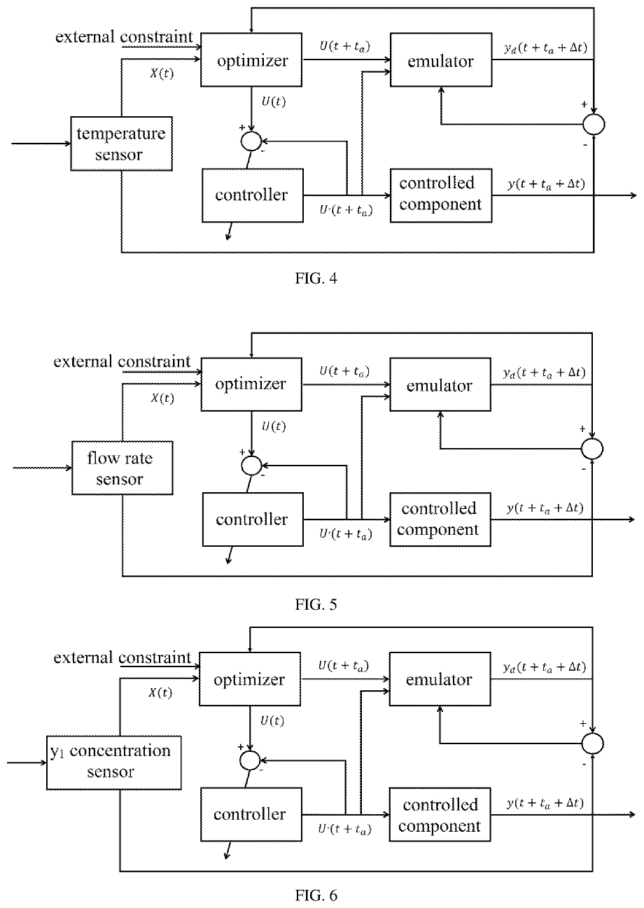

As shown in FIG. 3 and FIGS. 4-9, the temperature feedback controller 2, the flow rate feedback controller 3, and each feedback controller in the feedback controller group each contains a sensor 8, an optimizer 9, an emulator 10, a controller 11, and a controlled component 12, the output end of the sensor 8 is connected with the input end of the optimizer 9, the output end of the optimizer 9 is connected with the input end of the emulator 10, and the output end of the controller 11 is connected with the emulator 10 and the controlled component 12, respectively;
a first error regulator 13 is arranged between the output ends of the optimizer 9 and the controller 11, the information output by the optimizer 9 and the controller 11 is transmitted to the first error regulator 13, then the first error regulator 13 acts on the controller 11 to update control variables after having made an adjustment according to the error between the optimizer 9 and the controller 11;
a second error regulator 14 is arranged between the output ends of the emulator 10 and the controlled element 12, the second error regulator 14 acts on the emulator 10 to update an internal optimization model after having made an adjustment according to the error between the output ends of the emulator 10 and the controlled component 12, so as to correct an expected state of a next round of optimization and continuously carry out a cyclic feedback adjustment; an optimal control step needs to be given under internal control by way of repeating the prediction and optimization of an intellectualized algorithm in each time stage, and then the output solved by the controller acts on the sewage treatment device 1 when the optimal solution of the optimization problem has been obtained.

The operation of the temperature feedback controller (2), the flow rate feedback controller (3) and each feedback controller in the feedback controller group follows the steps of
S1: enabling a sensor 8 to detect an input-water index X(t+tₐ) of water resources at a moment t+tₐ, then transmit information to an optimizer 9, then entering S2, wherein after the sensor 8 serving as a terminal of obtaining and collecting data obtains required data, it transmits the data to a computer or a controller (such as MCU), which sends instructions and transmits information to the optimizer 9, so as realize controlling the optimizer 9;
S2: enabling the optimizer 9 to perform optimization and seek the solution according to a set water quality target value and a real-time simulation model input from an emulator 10, and give a current control variable U(t+tₐ), meanwhile entering S3 and S4, wherein from the conventional technical means in the computer field, it is knowable that the optimizer 9 and the emulator 10 need to operate under the control of a computer or a controller (such as MCU);
S3: enabling a control variable U(t+tₐ) to act on the emulator 10 for simulation to output a result Yd(t+tₐ+Δt), then entering S7, wherein from the conventional technical means in the computer field, it is knowable that the operations of the emulator 10 such as processing the control variable need to be executed under the control of a computer or a controller (such as MCU);
S4: enabling the controller 11 to actually output a control variable U′(t+tₐ) according to existing data after having received the information that the optimizer 9 transmits, then entering S5, wherein from the conventional technical means in the computer field, it is knowable that the operations of the emulator 10 such as processing the control variable need to be executed under the control of a computer or a controller (such as MCU);
S5: enabling the information U(t+tₐ) output, controlled and calculated by the optimizer 9 and the information U′(t+tₐ) actually output by the controller 11 to be transmitted to a first error regulator 13, and enabling the first error regulator 13 to act on the controller (11) for an adaptive stability adjustment of the controller 11 after having made an adjustment according to the error between the above two, then entering S6, wherein from the conventional technical means in the computer field, it is knowable that this kind of electronic components such as the optimizer 9 and the first error regulator 13 need to operate under the control of a computer or a controller (such as MCU), and the controller 11 may be a DSP controller or an embedded controller or an MCU;
S6: enabling an actual output control variable U′(t+tₐ) to act on the sewage treatment device to output an actual output variable Y(t+tₐ+Δt), if the error between the actual output variable Y(t+tₐ+Δt) and a target value is bigger than an allowable error, then entering S7; if the error between the actual output variable Y(t+tₐ+Δt) and a target value is smaller than an allowable error, then entering S8, wherein in general, the sewage treatment device has a built-in data processing chip, which may be a DSP chip or an embedded chip or a MCU chip, so as have the ability to process a variety or a plurality of data through the processing of this kind of microcomputers;
S7: enabling the information output by the emulator 10 and a controlled component 12 to be transmitted to a second error regulator 14, and enabling the second error regulator 14 to act on the emulator 10 to update a real-time simulation model after having made an adjustment according to the error between the above two, then entering S2, wherein from the conventional technical means in the computer field, it is knowable that this kind of electronic components such as the emulator 10, the controlled component 12 and the second error regulator 14 need to operate under the control of a computer or a controller (such as MCU); and
S8: continuously carrying out cyclic feedback to adjust and optimize the target, the error between an actual water treatment effect and a target value being less than an allowable error, thus achieving optimization control, wherein from the conventional technical means in the computer field, it is knowable that this kind of operations such as cyclic feedback and optimization need to go under the control of a computer or a controller.

The specific real-time simulation model of the temperature feedback controller 2, the flow rate feedback controller 3 and the internal emulator 10 inside the feedback controller group is as follows.

$$min J ( y , u ) = {\sum }_{k = 1}^{N} {‖ y ( t + k ) - {y}_{d} ( t + k ) ‖}^{2}$$

$$s . t .$$

$$y ( t + 1 ) = f ( y ( k ) , u ( t ) ) \qquad ( 1 )$$

$$u ( t ) ∈ [ u , \overline{u} ] , t ∈ T \qquad ( 2 )$$

$$y ( t ) ∈ [ y , \overline{y} ] , t ∈ T \qquad ( 3 )$$

External constraints: the objective function indicates that the state y(t+k) and the desired state y_{d}(t+k) of the system should be close to each other as far as possible within coming N time stages; wherein Constraint (1) represents the dynamic characteristics of a controlled object, f represents an expected model not limited to various machine learning algorithms including a recurrent neural network, Constraints (2) and (3) represent the upper and lower limits of a control parameter u(t) and a state parameter y(t) for water treatment, respectively.

In the present disclosure, yₘ represents an input-water target, which may include a physical index such as transparency, smell, turbidity, color and temperature; a single component index such as concentrations of NH₃—N, Cr⁶⁺ and other ions and organic substance; a comprehensive component index such as total organic carbon, total phosphorus, total nitrogen, PH value, and total number of bacteria; an evaluative comprehensive index such as COD, hardness, alkalinity and BOD; a biological toxicity index such as concentrations of cyanide, mercury, lead and other toxic substances; a water quality transformable index such as chlorophyll, total phosphorus, total nitrogen and permanganate; and a process index such as sludge volume index (SVI) and pollution index (SDI), and the number of these indexes is m.

In the present disclosure, y refers to an output volume, which is an output-water index, that is, an optimal input-water volume, an optimal temperature, various pollutant removal rates and so on, which correspond to an input-water index, and the number of this index is m; u refers to a control variable, representing various operating conditions used in an actual sewage treatment process, which may include an addition quantity of certain chemical agents such as flocculants, de-emulsifiers and redox agents, an aeration parameter such as aeration intensity, suction volume and pump flow, operating power of blowers, filter presses, water pumps and other machines, an addition quantity of certain microorganisms, an addition quantity of activated sludge and so on, and the number of this variable is n; X refers to an m-order vector of the input signal, U refers to an n-order vector of the control variable, and Y refers to an m-order vector of the output volume.

EXAMPLE: A water resource control system through multi-stage cyclic feedback includes a sewage treatment device, a temperature feedback controller, a flow rate feedback controller, a decider, and m−2 water quality index feedback controllers. The output end of the sewage treatment device is connected with the input ends of the temperature feedback controller, the flow rate feedback controller and the m−2 water quality index feedback controller, respectively; the output ends of the temperature feedback controller and the flow rate feedback controller are connected with the input end of the decider; the output end of the decider is connected with the input ends of the sewage treatment device and the y₃ feedback controller, respectively; the output end of the y₃ feedback controller is connected with the input ends of the sewage treatment device and the y₄ feedback controller, respectively; the output end of the y₄ feedback controller is connected with the input ends of the sewage treatment device and the y₅ feedback controller, respectively; and so on, until the output end of the yₘ feedback controller is connected with the input end of the sewage treatment device.

Preferably, a concentration controller is selected as the feedback controller.

Preferably, a digital infrared temperature sensor, model FT-H20, produced by Keyence (China) Co., Ltd. may be selected as the temperature sensor in the present disclosure; a clamp-type flowmeter, model FD-R200, produced by Keyence (China) Co., Ltd. may be selected as the flow sensor.

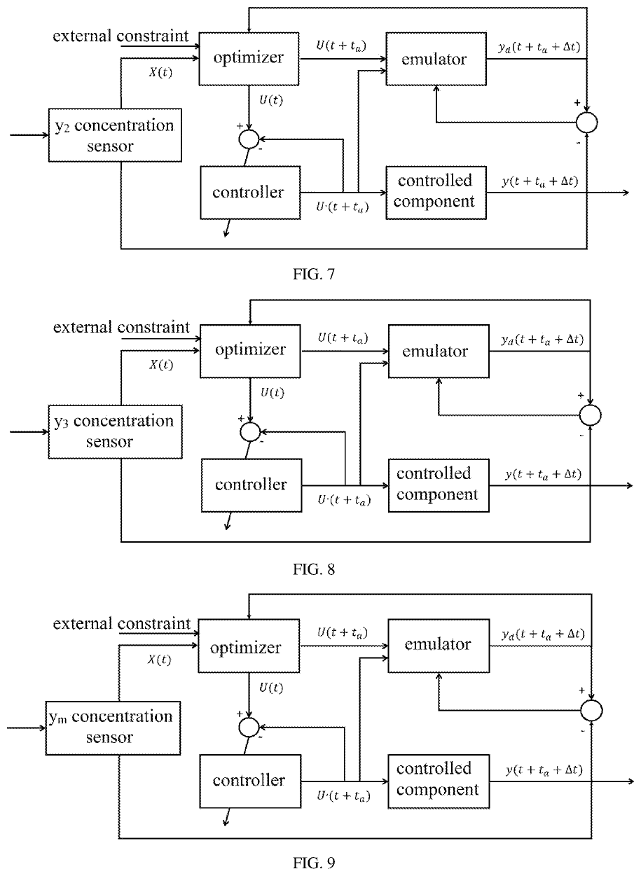

Preferably, a rapid monitoring meter produced by Qingdao Jingcheng Instrument Co., Ltd. with optional model number, JC-200, LB-50, JC-400 and JC-500 may selected as the y₁ concentration sensor at the input end of the y₁ feedback controller (as shown in FIG. 6), the y₂ concentration sensor at the input end of the y₂ feedback controller (as shown in FIG. 7), the y₃ concentration sensor at the input end of the y₃ feedback controller (as shown in FIG. 8), and the yₘ concentration sensor at the input end of the yₘ feedback controller (as shown in FIG. 9).

A person skilled in the art may choose a model according to the actual situation, and how to choose the model is not limited to the description of the present disclosure.

The operation of the system includes the following steps.
Step 1: obtaining a target value of an input-water index and establishing an optimal control model for the inlet index;
Step 2: adjusting temperatures and flow rates;
Step 3: determining whether the temperature and flow rate conditions meet the requirements;
Step 4: adjusting other operating conditions;
Step 5: achieving the target value of the water quality index.

From the conventional technical means in the computer field and the automatic control field, it is knowable that the operations such as establishment of the optimal control model, regulation of temperature and flow rate and judgment of conditions need to go under the control of a computer or a microcomputer or a control chip; therefore, Steps 1-5 are controlled, operated, and executed by a computer or a microcomputer or a control chip.

In Step 2, the temperature feedback controller and the flow rate feedback controller detect the input-water index X₁(t) at a moment t, then firstly make feedback and adjustment on the water temperature and flow rate.

In Step 3, the decider determines whether the difference between the current output result and the previous output result both coming from the temperature feedback controller or the flow rate feedback controller meets the minimum requirement of Δy₁ₘᵢₙ or Δy₂ₘᵢₙ. If it meets the requirement, the output results of the temperature and flow rate act on the sewage treatment device, then carry out water quality adjustment in the next step, if it meets the requirement, a cyclic feedback adjustment for the temperature and flow rate needs to go on.

In Step 4, after the water temperature and flow rate in the input-water index is fed back and adjusted to reach an optimum, the other operating conditions in the input-water index are adjusted to an optimum through multi-stage cyclic feedback. During adjusting other operating conditions, an external control system executes the following steps.
S1: enabling a multi-stage yₐ cyclic feedback controller to feedback and adjust only one water quality index to output an optimal operating condition Uₐ for this water quality index through optimization and adjustment.
S2: making the optimal operating condition Uₐ act on the sewage treatment device to obtain an overall water quality index output Yₐ under this operating condition, and using the overall water quality index output Yₐ as an input Xₐ₊₁ of a next multi-stage yₐ₊₁ cyclic feedback controller.

An internal control system executes the following steps.
S1: enabling a sensor to detect an input-water index X(t+tₐ) of water resources at a moment 1+tₐ, then transmit information to an optimizer, then entering S2;
S2: enabling the optimizer to perform optimization and seek the solution according to a set water quality target value and a real-time simulation model input from an emulator, and give a current control variable U(t+tₐ), meanwhile entering S3 and S4;
S3: enabling a control variable U(t+tₐ) to act on the emulator for simulation to output a result Y_{d}(t+tₐ+Δt);
S4: enabling the optimizer to transmit information to the controller, then enabling the controller to actually output a control variable U′(t+tₐ) according to existing data and entering S5;
S5: enabling the information output, controlled and calculated by the optimizer and the information actually output by the controller to be transmitted to a first error regulator, and enabling the first error regulator to act on the controller for an adaptive stability adjustment of the controller after having made an adjustment according to the error between the above two;
S6: enabling an actual output control variable U′(t+tₐ) to act on the sewage treatment device to output an actual output variable Y(t+tₐ+Δt), then entering S7 and S8;
S7: enabling the information output by the emulator and a valve to be transmitted to a second error regulator, and enabling the second error regulator to act on the emulator to update a prediction model after having made an adjustment according to the error between the above two, then entering S2; and
S8: continuously carrying out cyclic feedback to adjust and optimize the target, the error between an actual water treatment effect and a target value being less than an allowable error, thus achieving optimization control.

In S5, the last multi-stage yₘ cyclic feedback controller has finished optimization and adjustment and has executed a corresponding operating condition on the sewage treatment device, thus all output-water quality indexes of the entire multi-stage cyclic water resource control system resources have reached a target value. The control system runs all the time in the sewage treatment process, and adjusts sewage treatment conditions such as temperatures, flow rates, chemical addition quantities, aeration parameters, and microbial addition quantities in real time with the change of input-water quality indexes. After finishing the sewage treatment, the entire multi-stage cyclic water resource control system terminates.

It should be pointed out that a certain operating condition does not always correspond to one or several water quality indexes, but will make an influence on each other and play a roll mutually, so for any multi-stage cyclic feedback controller, the input-water quality index, the out-put water quality index, and the operating conditions need to be input or output together.

1. A multi-stage cyclic water resource control system, comprising a sewage treatment device (1), a temperature feedback controller (2), a flow rate feedback controller (3), a decider (4), and a feedback controller group;
wherein the output end of said sewage treatment device (1) is connected with the input ends of said temperature feedback controller (2) and said flow rate feedback controller (3), respectively; the output ends of said temperature feedback controller (2) and said flow rate feedback controller (3) are connected with the input end of said decider (4); the output end of said decider (4) is connected with the input ends of said sewage treatment device (1) and said feedback controller group, respectively; the output end of said feedback controller group is connected with the input end of said sewage treatment device (1).

2. The system according to claim 1, wherein said feedback controller group comprises a y₁ feedback controller (5), a y₂ feedback controller (6), a y₃ feedback controller (7), . . . , and yₘ feedback controller, where m is a positive integer;
the output end of said decider (4) is connected with the input ends of said sewage treatment device (1) and said y₁ feedback controller (5), respectively; the output end of said y₁ feedback controller (5) is connected with the input ends of said sewage treatment device (1) and said y₄ feedback controller (6), respectively; the output end of said y₂ feedback controller (6) is connected with the input ends of said sewage treatment device (1) and said y₃ feedback controller (7), respectively; and so on, until the output end of said yₘ feedback controller is connected with the input end of said sewage treatment device (1).

3. The system according to claim 1, wherein said temperature feedback controller (2), said flow rate feedback controller (3), and each feedback controller in said feedback controller group each contains a sensor (8), an optimizer (9), an emulator (10), a controller (11), and a controlled component (12), the output end of said sensor (8) is connected with the input end of said optimizer (9), the output end of said optimizer (9) is connected with the input end of said emulator (10), and the output end of said controller (11) is connected with said emulator (10) and said controlled component (12), respectively;
a first error regulator (13) is arranged between the output ends of said optimizer (9) and said controller (11), the information output by said optimizer (9) and said controller (11) is transmitted to said first error regulator (13), then said first error regulator (13) acts on said controller (11) to update control variables after having made an adjustment according to the error between said optimizer (9) and said controller (11); and
a second error regulator (14) is arranged between the output ends of said emulator (10) and said controlled element (12), said second error regulator (14) acts on the emulator (10) to update an internal optimization model after having made an adjustment according to the error between the output ends of said emulator (10) and said controlled component (12), so as to correct an expected state of a next round of optimization and continuously carry out a cyclic feedback adjustment; an optimal control step needs to be given under internal control by way of repeating the prediction and optimization of an intellectualized algorithm in each time stage, and then the output solved by the controller acts on said sewage treatment device (1) when the optimal solution of the optimization problem has been obtained.

4. The system according to claim 1, wherein the operation of said temperature feedback controller (2), said flow rate feedback controller (3) and each feedback controller in said feedback controller group follows the steps of
S1: enabling a sensor (8) to detect an input-water index X(t+tₐ) of water resources at a moment t+tₐ, then transmit information to an optimizer (9), then entering S2;
S2: enabling said optimizer (9) to perform optimization and seek the solution according to a set water quality target value and a real-time simulation model input from an emulator (10), and give a current control variable U(t+tₐ), meanwhile entering S3 and S4;
S3: enabling a control variable U(t+tₐ) to act on said emulator (10) for simulation to output a result Y_{d}(t+tₐ+Δt), then entering S7;
S4: enabling a controller (11) to actually output a control variable U′(t+tₐ) according to existing data after having received the information that said optimizer (9) transmits, then entering S5;
S5: enabling the information U(t+tₐ) output, controlled and calculated by said optimizer (9) and the information U′(t+tₐ) actually output by said controller (11) to be transmitted to a first error regulator (13), and enabling said first error regulator (13) to act on said controller (11) for an adaptive stability adjustment of said controller (11) after having made an adjustment according to the error between the above two, then entering S6;
S6: enabling an actual output control variable U′(t+tₐ) to act on said sewage treatment device to output an actual output variable Y(t+tₐ+Δt), if the error between the actual output variable Y(t+tₐ+Δt) and a target value is bigger than an allowable error, then entering S7; if the error between the actual output variable Y(t+tₐ+Δt) and a target value is smaller than an allowable error, then entering S8;
S7: enabling the information output by said emulator (10) and a controlled component (12) to be transmitted to a second error regulator (14), and enabling said second error regulator (14) to act on said emulator (10) to update a real-time simulation model after having made an adjustment according to the error between the above two, then entering S2; and
S8: continuously carrying out cyclic feedback to adjust and optimize the target, the error between an actual water treatment effect and a target value being less than an allowable error, thus achieving optimization control.

5. The system according to claim 1, wherein the specific real-time simulation model of said temperature feedback controller (2), said flow rate feedback controller (3) and an internal emulator (10) inside said feedback controller group is as follows,
$$min J ( y , u ) = {\sum }_{k = 1}^{N} {‖ y ( t + k ) - {y}_{d} ( t + k ) ‖}^{2}$$
$$s . t .$$
$$y ( t + 1 ) = f ( y ( k ) , u ( t ) ) \qquad ( 1 )$$
$$u ( t ) ∈ [ u , \overline{u} ] , t ∈ T \qquad ( 2 )$$
$$y ( t ) ∈ [ y , \overline{y} ] , t ∈ T \qquad ( 3 )$$
where, external constraints: the objective function indicates that the state y(t+k) and the desired state y_{d}(t+k) of the system should be close to each other as far as possible within coming N time stages; wherein Constraint (1) represents the dynamic characteristics of a controlled object, f represents an expected model not limited to various machine learning algorithms including a recurrent neural network, Constraints (2) and (3) represent the upper and lower limits of a control parameter u(t) and a state parameter y(t) for water treatment, respectively.
